(19) United States
(12) Patent Application Publication
(10) Pub. No.: US 2013/0161166 A1
(43) Pub. Date: Jun. 27, 2013

(54) POWER TOOL SWITCHING DEVICE

(71) Applicant: Robert Bosch GmbH, Stuttgart (DE)

(72) Inventors: Florian Esenwein, Uhingen-Holzhausen (DE); Manfred Lutz, Filderstadt (DE); Thomas Schomisch, Filderstadt (DE); Achim Trick, Sielmingen (DE)

(73) Assignee: Robert Bosch GmbH, Stuttgart (DE)

(21) Appl. No.: 13/691,248

(22) Filed: Nov. 30, 2012

(30) Foreign Application Priority Data
Dec. 23, 2011 (DE) 10 2011 089 717.8

(51) Int. Cl. H01H 9/00

(52) U.S. Cl. CPC H01H 9/00
USPC 200/329

(57) ABSTRACT

A power tool switching device, in particular for portable power tools, includes at least one switching unit having at least one movably mounted control element configured to actuate a mechanical, electrical and/or electronic switching element. The power tool switching device further includes at least one guide unit, which, upon an actuation of the control element along a direction of main extent of the control element, is configured to convert a movement of the control element along the direction of main extent at least into a movement of the control element running transversely in relation to the direction of main extent.

This application claims priority under 35 U.S.C. §119 to patent application no. DE 10 2011 089 717.8, filed on Dec. 23, 2011 in Germany, the disclosure of which is incorporated herein by reference in its entirety.

### BACKGROUND

There are already known power tool switching devices, in particular for portable power tools, that comprise a switching unit having a movably mounted control element for actuating a mechanical, electrical and/or electronic switching element.

### SUMMARY

The disclosure is based on a power tool switching device, in particular for portable power tools, comprising at least one switching unit having at least one movably mounted control element for actuating a mechanical, electrical and/or electronic switching element.

It is proposed that the power tool switching device comprises at least one guide unit, which is provided, upon an actuation of the control element along a direction of main extent of the control element, to convert a movement of the control element along the direction of main extent at least into a movement of the control element running transversely in relation to the direction of main extent. The complete control element in this case can execute a movement along the direction of main extent and, consecutive thereto, a movement in a direction running transversely in relation to the direction of main extent, or the control element can execute a movement along the direction of main extent and, consecutively thereto, the control element can partially execute a movement in a direction running transversely in relation to the direction of main extent, such as, for example, a swivel movement about a swivel axis, in particular about a swivel axis running through the control element. The term “switching unit” is intended here to define, in particular, a unit provided to alter a state of a unit of higher order than the switching unit as a result of an actuation of at least the control element. Particularly preferably, the switching unit is provided to enable and/or interrupt an electrical power supply to a drive unit as a result of an actuation of the control element that acts upon the switching element of the switching unit, which switching element is realized as a mechanical, electrical and/or electronic switch and/or pushbutton. Preferably, the switching element realized as a mechanical, electrical and/or electronic switch and/or pushbutton is arranged in an electric circuit between an electrical power supply line such as, for example, a cable, on which there is a plug connector for connecting to a socket outlet, and a load such as, for example, a drive unit, realized as an electric motor, of the portable power tool. The term “provided” in this context is to be defined as specially designed and/or specially equipped. The expression “movably mounted” is intended here to define, in particular, a mounting of an element, the element, in particular decoupled from an elastic deformation of the element, having a capability to move along at least a travel distance greater than 1 mm, preferably greater than 2 mm, and particularly preferably greater than 5 mm, and/or a capability to move about at least one axis, by an angle greater than 2°, preferably greater than 5°, and particularly preferably greater than 10°.

A “guide unit” is to be understood here to be, in particular, a unit provided to guide a component during a movement in a plane along a defined path, by exerting at least one constraining force transversely in relation to a direction of movement. A “constraining force” is to be understood here to be, in particular, a force provided to prevent a component from moving in at least one direction and/or to keep the component, during a movement, on a path defined through exertion of the force upon the component. Preferably, the control element extends over at least a major part of a total length of a rod-shaped housing region of a power tool housing of the portable power tool, the total length running at least substantially parallel in relation to the direction of main extent, thereby enabling quite particularly secure and comfortable operation to be achieved by simple design means. In particular, the control element extends along 30% of the total length of the rod-shaped housing region, preferably along 50%, and particularly preferably along 75%. The rod-shaped housing region of the power tool housing of the portable power tool preferably constitutes a handle region that is gripped, or grasped, by an operator's hand for the purpose of operation and/or handling during machining of a workpiece by means of the portable power tool.

The expression “direction of main extent” is intended here to define, in particular, a direction along which a component has a maximum extent, the direction being realized, in particular, so as to be other than a diagonal and running at least substantially parallel to at least two edges of the component that delimit side walls of the component that face away from and are spaced apart from each other. Preferably, the direction of main extent of the control element, when mounted in the portable power tool, runs at least substantially parallel to a drive axis of the drive unit of the portable power tool. “Substantially parallel” is to be understood here to mean, in particular, an alignment of a direction relative to a reference direction, in particular in one plane, the direction deviating from the reference direction by, in particular, less than 8°, advantageously less than 5°, and particularly advantageously less than 2°. Preferably, the control element has two degrees of freedom, owing to guidance by means of the guide unit. Upon an actuation of the control element along the direction of main extent, the control element is preferably initially moved translationally along the direction of main extent, owing to the guidance by the guide unit, and then, owing to the guidance by means of the guide unit, swiveled into a direction running transversely in relation to the direction of main extent, and/or the control element executes a translational movement on which a swiveling movement is superimposed. By this means, advantageously, the control element can be made comfortable to operate. In addition, advantageously, it is possible to prevent a portable power tool, having the power tool switching device according to the disclosure, from being inadvertently started up as a result of a region of the portable power tool in which the control element is arranged being grasped by an operator's hand, and therefore to prevent an actuating force, running at least substantially perpendicular to the direction of main extent, from being exerted. Further, by means of a movement capability of the control element that is defined by the guide unit, in particular owing to the swiveling movement of the control element, in the direction of the switching element, that follows an initially translational movement in the case of an actuation of the control element, it is possible, advantageously, through a compressive force already being generated when the handle region is being grasped, for the control element to be comfortably held in a position of the control element that corresponds to the portable power tool being in a switched-on state.

Furthermore, it is proposed that the switching unit has at least one blocking element, which is provided to block a movement of the control element in at least one direction, in at least one operating state. A “blocking element” is to be understood here to be, in particular, an element provided to prevent, insofar as possible, a movement of a movably mounted component along at least one travel distance and/or about at least one axis by means of a mechanical, electrical and/or electronic blocking means, in at least one operating state. Preferably, the blocking element is provided to prevent, insofar as possible, a movement of the movably mounted control element by means of a mechanical blocking means, in at least one operating state. It is also conceivable, however, for the blocking element to prevent, insofar as possible, a movement of the control element by means of action of an electromagnetic force and/or action of a permanent-magnet force upon the control element such as, for example, by means of displaceable magnets, in at least one operating state. The blocking element is therefore preferably realized as a mechanical blocking element that is provided, as a result of a direct contact, with a stop of the switching unit that is arranged in the power tool housing of the portable power tool, when in a blocking position, to block a movement of the control element. It is also conceivable, however, for the switching unit to comprise a multiplicity of blocking elements, which are provided to block a movement of the control element by means of stops of the switching unit that are arranged in the power tool housing of the portable power tool. A number of stops arranged in the power tool housing preferably corresponds to a number of blocking elements. The blocking elements in this case can be arranged with an even and/or uneven distribution on the control element and/or on the power tool housing. Particularly preferably, the blocking element is movably mounted on the control element. The design according to the disclosure, advantageously, in addition to preventing inadvertent startup of the portable power tool, by means of the movement capability of the control element defined by the guide unit, achieves a high degree of protection against inadvertent startup of the portable power tool. Advantageously, therefore, it is possible to achieve a high degree of protection against injury to an operator resulting from inadvertent startup of the portable power tool.

Advantageously, the switching unit has at least one spring element, which is provided to apply a spring force to the control element in at least one operating position. Particularly preferably, the spring element is provided to apply a spring force to the control element in the direction of an initial position of the control element. Preferably, an electrical power supply to the drive unit is interrupted when the control element is in an initial position, owing to the switching element not being actuated. A “spring element” is to be understood to be, in particular, a macroscopic element having at least one extent that, in a normal operating state, can be varied elastically by at least 10%, in particular by at least 20%, preferably by at least 30%, and particularly advantageously by at least 50% and that, in particular, generates a counter-force, which is dependent on a variation of the extent and preferably proportional to the variation and which counteracts the variation. An “extent” of an element is to be understood to be, in particular, a maximum distance of two points of a perpendicular projection of the element on to a plane. A “macroscopic element” is to be understood to be, in particular, an element having an extent of at least 1 mm, in particular of at least 5 mm, and preferably of at least 10 mm Advantageously, it is possible to achieve an automatic movement of the control element into an operating position, in particular into an initial position. Particularly advantageously, therefore, a watchdog circuit can be achieved. A “watchdog” circuit is to be understood to be, in particular, a circuit that automatically deactivates the portable power tool in the case of a termination of an intentional activation of the portable power tool, for example in the case of unconsciousness and/or in the case of an intentional interruption of application of an actuating force upon the control element.

Further, it is proposed that the guide unit is realized as a slideway guide unit and/or as a pendulum rod guide unit. A “slideway guide unit” is to be understood here to be, in particular, a guide unit that, as a result of a bolt-shaped element engaging in a slideway realized as a control recess, defines, or controls, a movement capability and/or movement direction of a component. The term “pendulum rod guide unit” is intended here to define, in particular, a guide unit that, as a result of a rigid guide element being movably mounted on two components that are movable relative to each other, defines, or controls, a movement capability and/or movement direction. By simple design means it is possible for a movement of the control element along one direction to be converted into a movement of the control element in a further direction.

Particularly preferably, the guide unit has at least one guide element, which is provided to mount the control element in a swiveling manner. Preferably, a swivel axis runs at least substantially perpendicular to the direction of main extent of the control element. Particularly preferably, the guide element is provided to mount the control element in a swiveling manner when the control element is in an operating state in which a pure translational movement of the control element along the direction of main extent that prevails at the start of an actuation of the control element has been completed and/or in which, in particular, a translational movement and a swiveling movement are superimposed on each other. The design according to the disclosure advantageously enables the control element to be swiveled in, in order that an operator can comfortably hold the control element in an operating position of the control element that corresponds to the portable power tool being in a switched-on state.

In addition, it is proposed that the guide unit has at least one further guide element, realized as a groove, which has a guide track course that is at least partially angled relative to the direction of main extent of the control element, at least when the control element is in an initial position. The guide track course and the direction of main extent in this case preferably enclose an angle other than 90° and 180°. A “guide track course” is to be understood here to be, in particular, a course of a track, in particular of the groove, which defines a movement path of the control element during a movement, the course of the path being constituted by peripheral regions of the track, in particular of the groove, that run at least substantially parallel to each other and delimit the track. The guide element, realized as a groove, is preferably arranged in an inside of the power tool housing of the portable power tool that faces toward the control element. Arranged on the control element in this case, preferably, is at least one bolt-shaped engagement element of the guide unit, which engages in the guide element, realized as a groove, for the purpose of guiding the control element. Preferably, the engagement element is integrally formed on to the control element. It is also conceivable, however, for the engagement element to be realized separately from the control element and to be fixedly connected to the control element by means of a connection type considered appropriate by persons skilled in the art, such as, for example, a positive and/or non-positive connection type. In addition, however, it is also conceivable for the guide element, realized as a groove, to be arranged on the control element, and for the engagement element to be arranged on the inside of the power tool housing. The design according to the disclosure, by simple design means, makes it possible for a translational movement along the direction of main extent to be converted into a direction running transversely in relation to the direction of main extent.

Furthermore, it is proposed that the guide unit has at least one guide element realized as a pendulum rod. The expression “pendulum rod” is intended here to define, in particular, an element, in particular a rigid element, that is mounted in the manner of a linkage at two ends of the element that face away from each other. Advantageously, a movable mounting of the control element can be achieved at low cost. In addition, advantageously, it can be ensured that the control element can be moved when being used in very dirty environments such as, for example, environments that contain large amounts of dust or material removed from workpieces.

Advantageously, the control element has at least two ends that face away from each other, as viewed along the direction of main extent, at least one guide element of the guide unit being arranged at one end, and at least one further guide element of the guide unit being arranged at a further end that faces away from the end, when the control element is in the mounted state. Preferably, two guide elements of the guide unit are arranged at the end, and two further guide elements of the guide unit are arranged at the further end. The guide elements and the further guide elements are preferably realized as grooves, in which there engage engagement elements of the guide unit that are fixedly connected to the control element, for the purpose of guiding the control element, and/or the guide elements and the further guide elements are realized as pendulum rods, which are movably mounted on the control element. Advantageously, precise guidance of the control element during a movement can be achieved. In addition, in particular if two guide elements are arranged at one end and two further guide elements are arranged at the further end of the control element, it is possible to achieve an advantageously symmetrical arrangement of the guide elements and/or of the further guide elements on and/or in the power tool housing of the portable power tool, to enable the control element to be guided in an advantageously stable manner during a movement.

Further, the disclosure is based on a portable power tool having a power tool switching device according to the disclosure. A “portable power tool” is to be understood here to be, in particular, a power tool for machining of workpieces, that can be transported by an operator without a transport machine. The portable power tool has, in particular, a mass of less than 40 kg, preferably less than 10 kg, and particularly preferably less than 5 kg. Particularly preferably, the portable power tool is realized as an angle grinder. It is also conceivable, however, for the portable power tool to be of a different design, considered appropriate by persons skilled in the art, such as being designed, for example, as a manual planing machine, as a multifunction power tool, as a portable milling machine, as a grinding machine and/or as an electrically operated garden appliance. Advantageously, a high degree of operating comfort can be achieved for an operator of the portable power tool.

The power tool switching device according to the disclosure and/or the power tool according to the disclosure in this case is/are not intended to be limited to the application and embodiment described above. In particular, for the purpose of fulfilling a mode of operation described herein, the power tool switching device according to the disclosure and/or the power tool according to the disclosure can have a number of individual elements, components and units that differs from a number stated herein.

### BRIEF DESCRIPTION OF THE DRAWINGS

Further advantages are given by the following description of the drawings. The drawings show exemplary embodiments of the disclosure. The drawings, the description, and the claims contain numerous features in combination. Persons skilled in the art will also expediently consider the features individually and combine them to create appropriate further combinations.

In the drawings:

FIG. 1 shows, in a schematic representation, a portable power tool according to the disclosure comprising a power tool switching device according to the disclosure,

FIG. 2 shows, in a schematic representation, a detail view of the power tool switching device according to the disclosure, when a control element of a switching unit of the power tool switching device according to the disclosure is in an initial position,

FIG. 3 shows, in a schematic representation, a detail view of the power tool switching device according to the disclosure, when the control element is in a switch-on position,

FIG. 4 shows, in a schematic representation, a detail view of an alternative power tool switching device according to the disclosure, when a control element of a switching unit of the alternative power tool switching device according to the disclosure is in an initial position,

FIG. 5 shows, in a schematic representation, a detail view of the alternative power tool switching device according to the disclosure from FIG. 4, when the control element is in the initial position, with a blocking element of the switching unit in a release position,

FIG. 6 shows, in a schematic representation, a detail view of a further alternative power tool switching device according to the disclosure, when a control element of a switching unit of the alternative power tool switching device according to the disclosure is in an initial position,

FIG. 7 shows, in a schematic representation, an exploded view of the further alternative power tool switching device according to the disclosure from FIG. 6, when the control element is in a switch-on position,

FIG. 8 shows, in a schematic representation, a detail view of a further alternative power tool switching device according to the disclosure, when a control element of a switching unit of the alternative power tool switching device according to the disclosure is in an initial position,

FIG. 9 shows, in a schematic representation, a detail view of a further alternative power tool switching device according to the disclosure, when a control element of a switching unit of the alternative power tool switching device according to the disclosure is in an initial position,

FIG. 10 shows, in a schematic representation, a detail view of the further alternative power tool switching device according to the disclosure from FIG. 9, when the control element is in a switch-on position,

FIG. 11 shows, in a schematic representation, a detail view of a further alternative power tool switching device according to the disclosure, when a control element of a switching unit of the alternative power tool switching device according to the disclosure is in an initial position, and

FIG. 12 shows, in a schematic representation, a detail view of the further alternative power tool switching device according to the disclosure from FIG. 11, when the control element is in a switch-on position.

### DETAILED DESCRIPTION

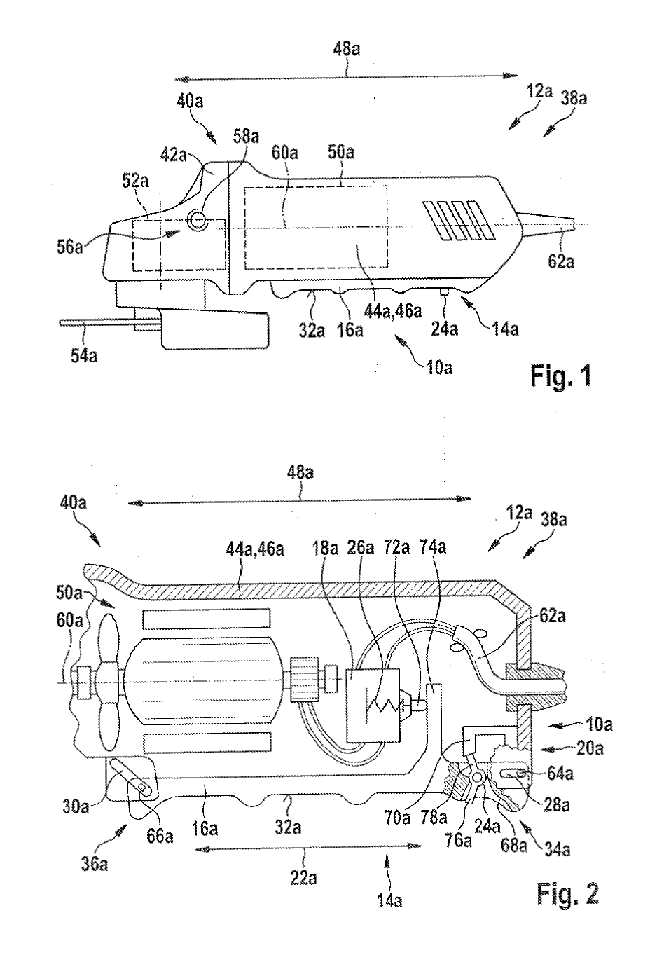

FIG. 1 shows a portable power tool 12a, realized as an angle grinder 38a, comprising a power tool switching device 10a. The angle grinder 38a has a power tool housing 40a, which comprises a transmission housing 42a and a motor housing 44a. The power tool housing 40a is of a pot-type design. It is also conceivable, however, for the power tool housing 40a to be of a shell-type design, or a combination of a pot-type and shell-type design. Further, the angle grinder 38a has a main handle 46a, which is constituted by the motor housing 44a. The main handle 46a, starting from the transmission housing 42a, extends in a direction that faces away from the transmission housing 42a and that runs at least substantially parallel to a direction of main extent 48a of the angle grinder 38a. The main handle 46a in this case has an at least substantially cylindrical shape. It is also conceivable, however, for the main handle 46a to have a different shape, considered appropriate, in particular ergonomically appropriate, by persons skilled in the art.

The motor housing 44a is provided to receive a drive unit 50a of the angle grinder 38a. The transmission housing 42a is provided to receive an output unit 52a of the angle grinder 38a, which output unit comprises a drive spindle (not represented in greater detail here) for driving a machining tool 54a in rotation. An auxiliary-handle fastening device 56a is arranged on the transmission housing 42a. The auxiliary-handle fastening device 56a has a multiplicity of auxiliary-handle receiving elements 58a (only one auxiliary-handle receiving element 58a can be seen in FIG. 1), which are arranged in an evenly distributed manner along a circumferential direction on the transmission housing 42a. The auxiliary-handle receiving elements 58a are provided to receive a fastening region of a removable auxiliary handle (not represented in greater detail here). The fastening region of the auxiliary handle can be screwed into the auxiliary-handle receiving elements 58a, for example by means of a screwed connection, for the purpose of fixing the auxiliary handle to the transmission housing 42a. When the fastening region of the auxiliary handle is in a mounted state in an auxiliary-handle receiving element 58a, the auxiliary handle extends transversely in relation to the direction of main extent 48a of the angle grinder 38a.

FIG. 2 shows a detail view of the power tool switching device 10a when a control element 16a of a switching unit 14a of the power tool switching device 10a is in an initial position. The power tool switching device 10a thus comprises at least the switching unit 14a, which comprises at least the movably mounted control element 16a for actuating a mechanical, electrical and/or electronic switching element 18a of the switching unit 14a. The switching unit 18a is electrically connected to a power supply cable 62a and to the drive unit 50a, in a manner already known to persons skilled in the art. The switching element 18a is thus provided, when in a non-actuated state, to break an electric circuit for supplying electrical power to the drive unit 50a and, when in an actuated state, to close the electric circuit for supplying electrical power to the drive unit 50a. When the control element 16a is in the initial position, the switching element 18a is not being actuated by the control element 16a. In this case, an electrical power supply to the drive unit 50a is interrupted when the control element 16a is in the initial position. Thus, when the control element 16a is in the initial position, no electric current is supplied to the drive unit 50a.

The control element 16a is arranged on the main handle 46a, on a side of the main handle 46a that faces toward the drive spindle. Alternatively, the control element 16a could also be arranged on a side of the main handle 46a that faces away from the drive spindle, or on another side considered appropriate by persons skilled in the art. In particular, the main handle 46a could be mounted so as to be rotatable relative to the transmission housing 42a. The control element 16a extends along the direction of main extent 22a of the control element 16a on the main handle 46a, or on the motor housing 44a. A total extent of the control element 16a along the direction of main extent 22a corresponds in this case to approximately 80% of a total extent of the main handle 46a along the direction of main extent 48a of the angle grinder 38a. The control element 16a has a control surface 32a having an at least substantially rectangular projection surface. The switching element 18a is arranged in the interior space enclosed by the main handle 46a, or by the motor housing 44a. The switching element 18a in this case is arranged in a region of the interior space that is arranged on a side of the main handle 46a, or of the motor housing 44a, that faces away from the transmission housing 42a. It is also conceivable, however, for the switching element 18a to be arranged at a different position, considered appropriate by persons skilled in the art, in and/or on the main handle 46a, or on the motor housing 44a.

For the purpose of movable mounting and guidance during a movement of the control element 16a, the power tool switching device 10a has at least one guide unit 20a. The guide unit 20a is provided, upon an actuation of the control element 16a along a direction of main extent 22a of the control element 16a, to convert a movement of the control element 16a along the direction of main extent 22a at least into a movement of the control element 16a running transversely in relation to the direction of main extent 22a. The direction of main extent 22a of the control element 16a in this case, when the control element 16a is in the initial position, runs at least substantially parallel to the direction of main extent 48a of the angle grinder 38a. In addition, the direction of main extent 22a of the control element 16a, when the control element 16a is in the initial position, runs at least substantially parallel to a drive axis 60a of the drive unit 50a. The control element 16a has at least two ends 34a, 36a that face away from each other, as viewed along the direction of main extent 22a, at least one guide element 28a of the guide unit 20a being arranged at an end 34a of the control element 16a that faces away from the transmission housing 42a, and at least one further guide element 30a of the guide unit 20a being arranged at a further end 36a of the control element 16a that faces away from the end 34a and toward the transmission housing 42a, when the control element 16a is in a mounted state.

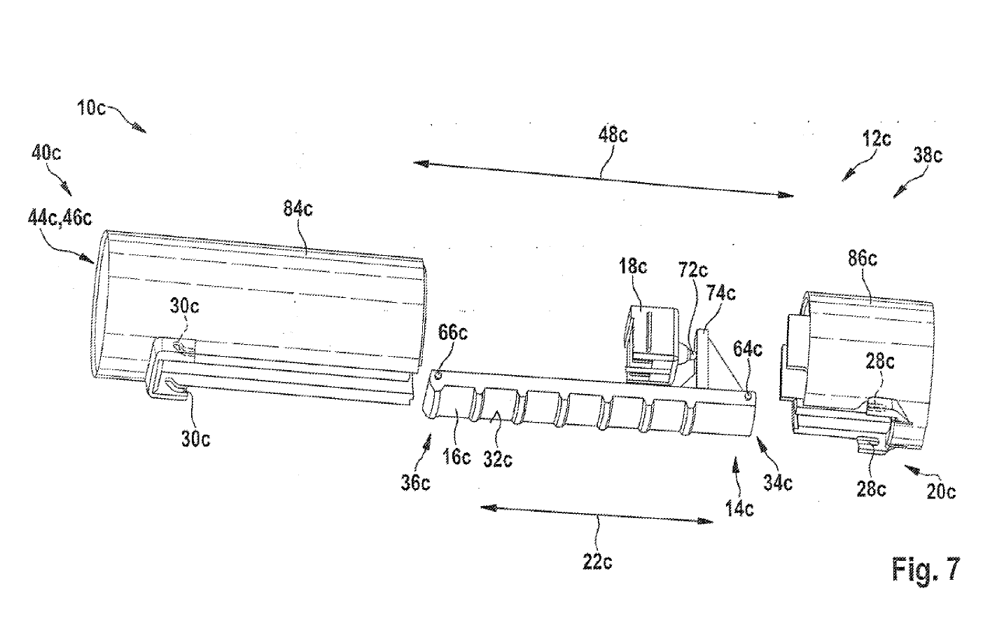

The guide unit 20a has a total of two guide elements 28a, which are arranged at the end 34a of the control element 16a that faces away from the transmission housing 42a, and two further guide elements 30a, which are arranged at the further end 36a of the control element 16a that faces toward the transmission housing 42a (FIG. 2 shows only one of the two guide elements 28a and one of the two further guide elements 30a). The two guide elements 28a are similar to each other in shape. Further, the two further guide elements 30a are likewise similar to each other in shape. In this case, respectively one of the two guide elements 28a and one of the two further guide elements 30a are arranged in a common plane, which runs at least substantially perpendicular to the control surface 32a of the control element 16a. The guide element that is not represented and the further guide element that is not represented are arranged in a further common plane that runs at least substantially parallel to the common plane of the represented guide element 28a and of the further represented guide element 30a (cf. in this respect also FIG. 7, which shows an alternative exemplary embodiment of the power tool switching device 10a). The common plane of the represented guide element 28a and of the further represented guide element 30a is represented in FIG. 2 by the plane of the figure, the further common plane being arranged along a direction that runs at least substantially perpendicular to the plane of the figure, in particular into the plane of the figure, at a distance from the common plane of the represented guide element 28a and of the further represented guide element 30a. The guide elements 28a and the further guide elements 30a are each realized as a groove, which grooves are arranged on an inside of the main handle 46a, or of the motor housing 44a, that faces toward the control element 16a. It is conceivable for the guide elements 28a, realized as grooves, and the further guide elements 30a, realized as grooves, to be open on one side for the purpose of mounting the control element 16a.

The further guide elements 30a realized as grooves each have a guide track course that is at least partially angled relative to the direction of main extent 22a of the control element 16a, at least when the control element 16a is in the initial position. In this case, the further guide elements 30a realized as grooves enclose with the direction of main extent 22a of the control element 16a an angle other than 90° and 180° when the control element 16a is in the initial position. Further, the guide track course of the further guide elements 30a realized as grooves are aligned obliquely relative to the drive axis 60a of the drive unit 50a. The guide elements 28a arranged at the end 34a of the control element 16a that faces away from the transmission housing 42a each have a guide track course that extends at least substantially parallel to the direction of main extent 22a of the control element 16a when the control element 16a is in the initial position. The guide elements 28a realized as grooves thus run at least substantially parallel to the drive axis 60a of the drive unit 50a.

For the purpose of movably mounting and guiding the control element 16a by means of the guide unit 20a, the guide unit 20a comprises engagement elements 64a, 66a, which are fixed to the control element 16a. The guide unit 20a has a total of four engagement elements 64a, 66a, which are fixed to the control element 16a (FIG. 2 shows only two of the four engagement elements 64a, 66a, the engagement elements that are not shown being arranged in a mirror-image manner on a plane on the control element 16a that runs at least substantially perpendicular to the control surface 32a). The engagement elements 64a, 66a are realized so as to be integral with the control element 16a. It is also conceivable, however, for the engagement elements 64a, 66a to be fixed to the control element 16a by means of a positive and/or non-positive connection. When the control element 16a is in a mounted state, the engagement elements 64a, 66a each engage in one of the guide elements 28a or in one of the further guide elements 30a. The engagement elements 64a, 66a in this case are realized as guide bolts, which have a cylindrical cross section. It is also conceivable, however, for the engagement elements 64a, 66a to be of a different shape, considered appropriate by persons skilled in the art. The guide unit 20a is thus realized as a slideway guide unit.

Furthermore, the switching unit 14a has at least one blocking element 24a, which is provided to block a movement of the control element 16a in at least one direction, in at least one operating state. The blocking element 24a is mounted in a swiveling manner on the control element 16a. The blocking element 24a in this case is arranged with spring bias in a recess 68a of the control element 16a. The blocking element 24a acts in combination with a stop element 70a of the switching unit 14a for the purpose of blocking a movement of the control element 16a along the direction of main extent 22a of the control element 16a. The stop element 70a is integrally formed on to the inside of the motor housing 44a, or of the main handle 46a, that faces toward the control element 16a. When the blocking element 24a is in a blocking position, the blocking element 24a thus, via the stop element 70a, supports an actuating force, which acts upon the control element 16a, on the motor housing 44a, or on the main handle 46a. For the purpose of releasing the blocking position, the blocking element 24a is swiveled about a swivel axis, contrary to a spring force, by an operator. The blocking element 24a has two limbs that extend in directions facing away from the swivel axis. One limb of the blocking element 24a in this case is realized as an actuating limb 76a, which can be actuated by an operator, and one limb is realized as a blocking limb 78a, which bears against the stop element 70a when in the blocking position. The actuating limb 76a and the blocking limb 78a are each directly connected to the swivel axis. The blocking limb 78a is formed on to the actuating limb 76a, on a side of the actuating limb 76a that faces toward the swivel axis. Further, the actuating limb 76a and the blocking limb 78a each extend obliquely in relation to the direction of main extent 22a of the control element 16a when the blocking element 24a is in the blocking position and in a release position.

In addition, the switching unit 14a comprises at least one spring element 26a, which is provided to apply a spring force to the control element 16a in at least one operating position. The spring element 26a is realized as a compression spring. It is also conceivable, however, for the spring element 26a to be of a different design, considered appropriate by persons skilled in the art, such as, for example, designed as a tension spring, torsion spring, etc. The spring element 26a is provided to apply a spring force to the control element 16a in the direction of the initial position of the control element 16a. The spring element 26a in this case is a component of the switching element 18a, which component is provided to apply a spring force to an actuating striker 72a of the switching element 18a in the direction of a position of the switching element 18a that corresponds to a non-actuated state of the switching element 18a. It is also conceivable, however, for the spring element 26a to be realized separately from the switching element 18a and, for the purpose of applying a spring force to the control element 16a, to be supported by one end on the inside of the motor housing 44a, or of the main handle 46a, that faces toward the control element 16a and to be supported on the control element 16a by a further end.

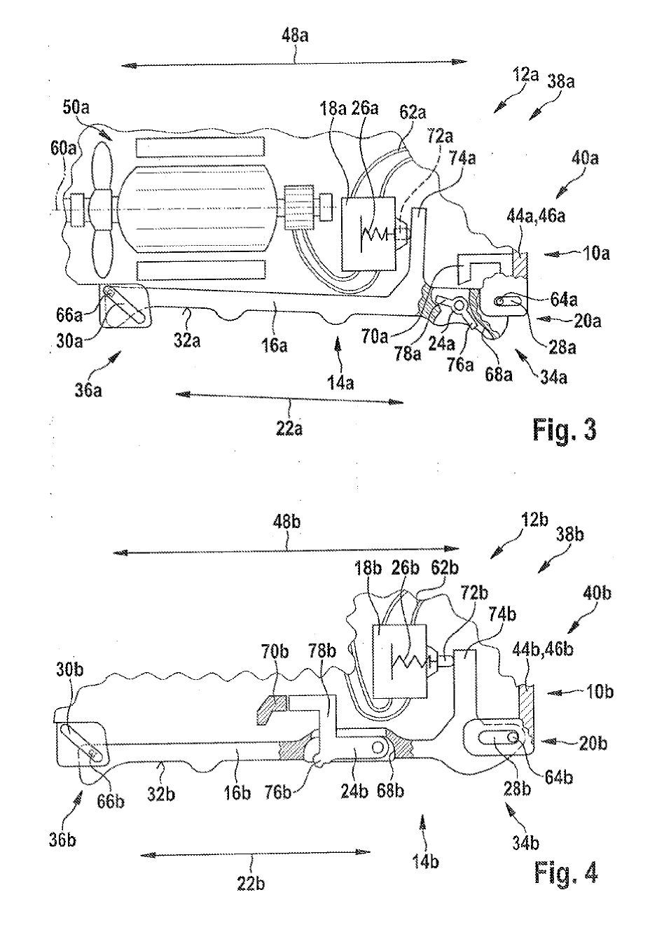

Upon an actuation of the control element 16a, starting from the initial position of the control element 16a, by means of application of force by an operator in the direction of the direction of main extent 22a of the control element 16a, the control element 16a, after release of the blocking position of the blocking element 24a as a result of the guidance by the guide unit 20a, executes a movement parallel to the direction of main extent 22a of the control element 16a, which movement is superimposed by a swivel movement about a swivel axis of the control element 16a that runs at least substantially perpendicular to the direction of main extent 22a of the control element 16a. The control element 16a is swiveled about the swivel axis, in a direction facing toward the motor housing 44a, or the main handle 46a. As a result of an actuation, therefore, the control element 16a goes at least partially into the motor housing 44a, or into the handle 46a. The control element 16a is thus moved from the initial position into a switch-on position (FIG. 3). In this case, the engagement elements 64a, 66a slide on peripheral regions of the guide elements 28a, realized as grooves, and on peripheral regions of the further guide elements 30a, realized as grooves.

The guide elements 28a arranged at the end 34a of the control element 16a that faces away from the transmission housing 42a, together with the engagement elements 64a that engage in the guide elements 28a, are provided to mount the control element 16a in a swiveling manner. The guide unit 20a therefore comprises at least the guide elements 28a provided for mounting the control element 16a in a swiveling manner. When the control element 16a is in the switch-on position, the actuating striker 72a of the switching element 18a is actuated by means of an actuating extension 74a of the control element 16a (FIG. 3). The actuating extension 74a is arranged on a side of the control element 16a that faces away from the control surface 32a. The actuating extension 74a in this case extends, at least substantially perpendicular to the direction of main extent 22a of the control element 16a, in a direction that faces away from the control element 16a. When the control element 16a is in the switch-on position, the electric circuit for supplying electrical power to the drive unit 50a is closed as a result of the actuation of the switching element 18a. As soon as a force applied to the control element 16a by an operator is interrupted, or falls below a minimum value, the control element 16a is moved into the initial position by means of a spring force of the spring element 26a. The blocking element 24a, as a result of being mounted with spring bias in the control element 16a, is moved into the blocking position when the initial position of the control element 16a is attained. A movement of the control element 16a in the direction of the switch-on position is thus blocked by means of a combined action of the blocking element 24a and the stop element 70a.

Alternative exemplary embodiments are represented in FIGS. 4 to 12. Components, features and functions that remain substantially the same are denoted essentially by the same references. In order to differentiate the exemplary embodiments, the letters a to f are added as a suffix to the references of the exemplary embodiments. The description that follows is restricted substantially to the differences in comparison with the first exemplary embodiment in FIGS. 1 to 3, and reference may be made to the description of the first exemplary embodiment in FIGS. 1 to 3 in respect of components, features and functions that remain the same.

FIG. 4 shows a detail view of an alternative power tool switching device 10b when a control element 16b of a switching unit 14b of the power tool switching device 10b is in an initial position. The power tool switching device 10b in this case is arranged in an angle grinder 38b, which comprises the power tool switching device 10b. The angle grinder 38b is of a structure similar to that of the angle grinder 38a from FIG. 1. The power tool switching device 10b comprises at least the switching unit 14b, which comprises at least the movably mounted control element 16b for the purpose of actuating a mechanical, electrical and/or electronic switching element 18b of the switching unit 14b. In addition, the power tool switching device 10b has a guide unit 20b, which is provided, upon an actuation of the control element 16b along a direction of main extent 22b of the control element 16b, to convert a movement of the control element 16b along the direction of main extent 22b at least into a movement of the control element 16b running transversely in relation to the direction of main extent 22b. In respect of a design of the guide unit, reference may be made to the guide unit 20a described in FIGS. 1 to 3, since the guide unit 20b is of a design similar to that of the guide unit 20a described in FIGS. 1 to 3.

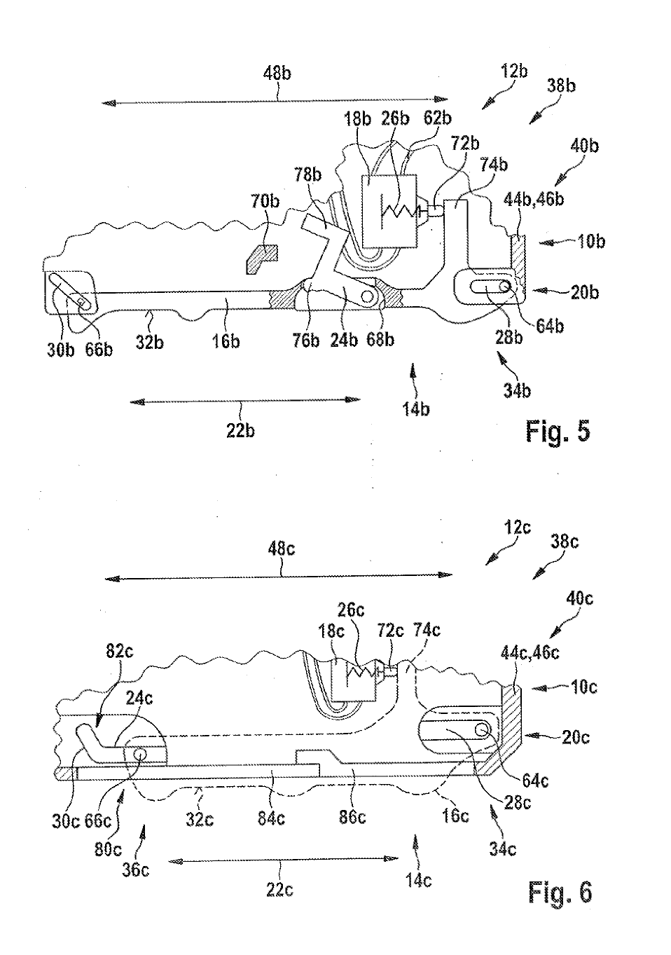

The switching unit 14b has at least one blocking element 24b, which is provided to block a movement of the control element 16b in at least one direction, in at least one operating state. The blocking element 24b is mounted in a swiveling manner on the control element 16b. The blocking element 24b in this case is arranged with spring bias in a recess 68b of the control element 16b. The blocking element 24b acts in combination with a stop element 70b of the switching unit 14b for the purpose of blocking a movement of the control element 16b along the direction of main extent 22b of the control element 16b. The stop element 70b is integrally formed on to the inside of a motor housing 44b, or of a main handle 46b, of the angle grinder 38b that faces toward the control element 16b. The blocking element 24b has an actuating limb 76b, which can be actuated by an operator, and has a blocking limb 78b, which bears against the stop element 70b when in a blocking position. The blocking limb 78b is realized so as to be integral with the actuating limb 76b. The blocking limb 78b in this case is of an L-shaped design. The blocking limb 78b is formed on to the actuating limb 76b, on a side of the blocking element 24b that faces away from a swivel axis. In addition, the blocking limb 78b is connected to the swivel axis via the actuating limb 76b. Further, when the blocking element 24b is in the blocking position, the actuating limb 76b and a blocking region of the blocking limb 78b extend at least substantially parallel to the direction of main extent 22b of the control element 16b. For the purpose of releasing the blocking position of the blocking element 24b, an operator exerts upon the blocking element 24b a force acting at least substantially perpendicular to a control surface 32b of the control element 16b. As a result, the blocking element 24b is swiveled in the direction of an interior space enclosed by the motor housing 44b, or by the main handle 46b (FIG. 5).

FIG. 6 shows a detail view of a further alternative power tool switching device 10c. The power tool switching device 10c in this case is arranged in an angle grinder 38c, which comprises the power tool switching device 10c. The angle grinder 38c is of a structure at least substantially similar to that of the angle grinder 38a from FIG. 1. The power tool switching device 10c is of a design at least substantially similar to that of the power tool switching device 10a described in the description of FIGS. 1 to 3. Only a guide unit 20c of the power tool switching device 10c is of a design that differs from that of the power tool switching device 10a described in the description of FIGS. 1 to 3.

The guide unit 20c has two guide elements 28c that, when the control element 16c is an initial position, run at least substantially parallel to a direction of main extent 22c of the control element 16c (FIG. 7). The guide elements 28c are each realized as a groove, which groove is open for the purpose of mounting the control element 16c in the direction of a transmission housing (not represented here in greater detail) of a power tool housing 40c of the angle grinder 38c. In addition, the guide unit 20c has two further guide elements 30c, realized as grooves, which each have a guide track course that is at least partially angled relative to the direction of main extent 22c of the control element 16c, when the control element 16c is in an initial position (FIG. 7). The further guide elements 30c in this case each have a partial region 80c that runs at least substantially parallel to the direction of main extent 22c of the control element 16c when the control element 16c is in the initial position, and have a further partial region 82c that is angled relative to the partial region 80c that runs at least substantially parallel to the direction of main extent 22c of the control element 16c. For the purpose of mounting the control element 16c, the partial region 80c that runs at least substantially parallel to the direction of main extent 22c of the control element 16c when the control element 16c is in the initial position is open in a direction that faces away from the transmission housing.

The guide elements 28c and the further guide elements 30c in this case are arranged, in a manner at least substantially similar to that of the guide elements 28a and the further guide elements 30a described in the description of FIGS. 1 to 3, on a motor housing 44c, or a main handle 46c, of the power tool housing 40c. The motor housing 44c is realized in two parts. The motor housing 44c in this case comprises a housing part 84c in the form of a hollow cylinder, and comprises a further, pot-type housing part 86c, which can be positively connected to the housing part 84c that is in the form of a hollow cylinder (FIG. 7). The guide elements 28c that run at least substantially parallel to the direction of main extent 22c of the control element 16c when the control element 16c is in the initial position are formed on to the pot-type housing part 86c. The further guide elements 30c, which have a guide track course that is at least partially angled relative to the direction of main extent 22c of the control element 16c when the control element 16c is in the initial position, are formed on to the housing part 84c that is in the form of a hollow cylinder.

Furthermore, a switching unit 14c comprises at least one blocking element 24c, which is provided, upon an actuation of the control element 16c, to block a movement of the control element 16c along a direction running at least substantially perpendicular to the direction of main extent 22c of the control element 16c. The blocking element 24c in this case is constituted by peripheral regions of the partial regions 80c of the guide elements 30c that run at least substantially parallel to the direction of main extent 22c of the control element 16c when the control element 16c is in the initial position.

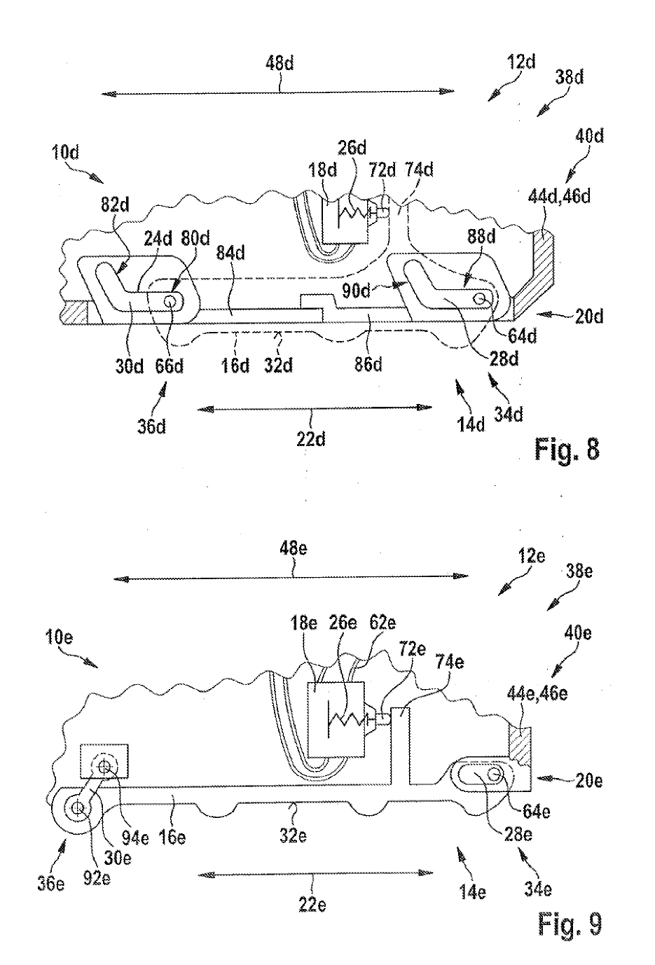

FIG. 8 shows a detail view of a further alternative power tool switching device 10d when a control element 16d of a switching unit 14d of the power tool switching device 10d is in an initial position. The power tool switching device 10d in this case is arranged in an angle grinder 38d, which comprises the power tool switching device 10d. The angle grinder 38d, not represented in greater detail, is of a structure at least substantially similar to that of the angle grinder 38a from FIG. 1. The power tool switching device 10d comprises at least the switching unit 14d, which comprises at least the movably mounted control element 16d for the purpose of actuating a mechanical, electrical and/or electronic switching element 18d of the switching unit 14d. In addition, the power tool switching device 10d has a guide unit 20d, which is provided, upon an actuation of the control element 16d along a direction of main extent 22d of the control element 16d, to convert a movement of the control element 16d along the direction of main extent 22d at least into a movement of the control element 16d running transversely in relation to the direction of main extent 22d.

The guide unit 20d has two guide elements 28d, realized as grooves, and has two further guide elements 30d, realized as grooves, which each have a guide track course that is at least partially angled relative to the direction of main extent 22d of the control element 16d, when the control element 16d is in the initial position. The guide elements 28d and the further guide elements 30d in this case each have a partial region 80d, 88d that runs at least substantially parallel to the direction of main extent 22d of the control element 16d when the control element 16d is in the initial position, and have a further partial region 82d, 90d that is angled relative to the partial region 80d, 88d that runs at least substantially parallel to the direction of main extent 22d of the control element 16d. Peripheral regions of the partial regions 80d, 88d that run at least substantially parallel to the direction of main extent 22d of the control element 16d when the control element 16d is in the initial position together constitute a blocking element 24d of the switching unit 14d. It is conceivable for the guide elements 28d, realized as grooves, and the further guide elements 30d, realized as grooves, to be open on one side for the purpose of mounting the control element 16d. The guide elements 28d and the further guide elements 30d in this case are arranged on a motor housing 44d, or on a main handle 46d of a power tool housing 40d, in a manner that is at least substantially similar to an arrangement of the guide elements 28c and the further guide elements 30c, described in the description of FIGS. 6 and 7, on the motor housing 44c, or on the main handle 46c of the power tool housing 40c.

FIG. 9 shows a detail view of a further alternative power tool switching device 10e when a control element 16e of a switching unit 14e of the power tool switching device 10e is in an initial position. The power tool switching device 10e in this case is arranged in an angle grinder 38e, which comprises the power tool switching device 10e. The angle grinder 38e, not represented in greater detail, is of a structure at least substantially similar to that of the angle grinder 38a from FIG. 1. The power tool switching device 10e comprises at least the switching unit 14e, which comprises at least the movably mounted control element 16e for the purpose of actuating a mechanical, electrical and/or electronic switching element 18e of the switching unit 14e. The switching unit 14e comprises at least one blocking element (not represented here), which is provided to block a movement of the control element 16e in at least one direction, in at least one operating state. The blocking element in this case can be realized in a manner similar to that of the blocking element 24a described in the description of FIGS. 1 to 3. In addition, the power tool switching device 10e has a guide unit 20e, which is provided, upon an actuation of the control element 16e along a direction of main extent 22e of the control element 16e, to convert a movement of the control element 16e along the direction of main extent 22e at least into a movement of the control element 16e running transversely in relation to the direction of main extent 22e.

The guide unit 20e has two guide elements 28e that, when the control element 16e is in the initial position, run at least substantially parallel to the direction of main extent 22e of the control element 16e (FIG. 9 shows only one of the two guide elements 28e). The guide elements 28e are realized as grooves. It is conceivable for the guide elements 28e, realized as grooves, to be open on one side for the purpose of mounting the control element 16d. When the control element 16e is in a mounted state, the guide elements 28e are arranged at an end 34e of the control element 16e that faces away from a transmission housing (not represented in greater detail here) of a power tool housing 40e of the angle grinder 38e. For the purpose of guiding a movement of the control element 16e, the guide unit 20e comprises engagement elements 64e, arranged on the control element 16e, which engage in the guide elements 28e. In addition, the guide unit 20e comprises two further guide elements 30e that, when the control element 16e is in a mounted state, are arranged at an end 36e of the control element 16e that faces toward the transmission housing (FIG. 9 shows only one of the two further guide elements 30e). The further guide elements 30e are realized as pendulum rods. The further guide elements 30e, realized as pendulum rods, are movably mounted on the control element 16e. The control element 16e in this case comprises trunnions 92e, on each of which one of the further guide elements 30e is movably mounted. In addition, the further guide elements 30e, realized as pendulum rods, are arranged in a movable manner on an inside of a motor housing 44e, or of a main handle 46e of the power tool housing 40e, that faces toward the control element 16e. The motor housing 44e, or the main handle 46e, in this case comprises trunnions 94e, on each of which one of the further guide elements 30e is movably mounted. The guide elements 28e and the further guide elements 30e are arranged relative to each other in a manner at least substantially similar to that of the guide elements 28a and the further guide elements 30a described in the description of FIGS. 1 to 3.

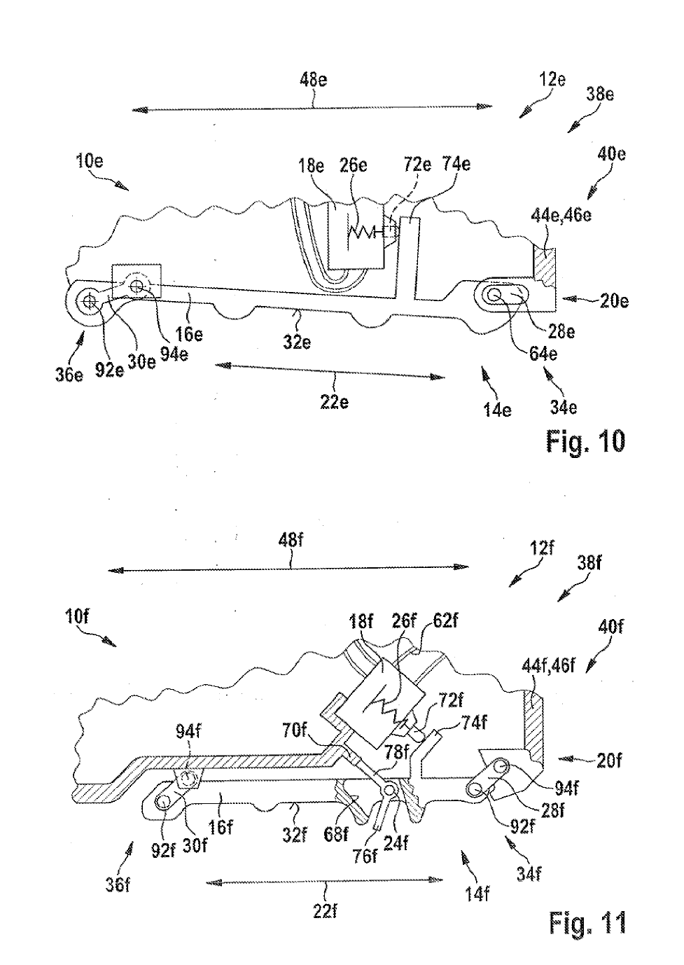

Upon an actuation of the control element 16e, starting from the initial position of the control element 16e, along the direction of main extent 22e of the control element 16e, the further guide elements 30e, realized as pendulum rods, are moved relative to the control element 16e and relative to the power tool housing 40e. By means of a combined action of the guide elements 28e that, when the control element 16e is in the initial position, run at least substantially parallel to the direction of main extent 22e of the control element 16e, and that are realized as grooves, and the further guide elements 30e, realized as pendulum rods, a movement resulting from an actuation of the control element 16e along the direction of main extent 22e of the control element 16e a movement of the control element 16e along the direction of main extent 22e is converted at least into a movement of the control element 16a running transversely in relation to the direction of main extent 22e. As a result, the control element 16e is moved from the initial position into a switch-on position (FIG. 10) by means of a translational movement, which is superimposed by a swivel movement about a swivel axis running at least substantially perpendicular to the direction of main extent 22e. The guide unit 20e is thus realized as a combination of a slideway guide unit and a pendulum rod guide unit.

FIG. 11 shows a detail view of a further alternative power tool switching device 10f when a control element 16f of a switching unit 14f of the power tool switching device 10f is in an initial position. The power tool switching device 10f in this case is arranged in an angle grinder 38f, which comprises the power tool switching device 10f. The angle grinder 38f, not represented in greater detail, is of a structure at least substantially similar to that of the angle grinder 38a from FIG. 1. The power tool switching device 10f comprises at least the switching unit 14f, which comprises at least the movably mounted control element 16f for the purpose of actuating a mechanical, electrical and/or electronic switching element 18f of the switching unit 14f. In addition, the power tool switching device 10f comprises a guide unit 20f, which is provided, upon an actuation of the control element 16f along a direction of main extent 22f of the control element 16f, to convert a movement of the control element 16f along the direction of main extent 22f at least into a movement of the control element 16f running transversely in relation to the direction of main extent 22f.

The guide unit 20f has two guide elements 28f realized as pendulum rods (FIG. 11 shows only one of the two guide elements 28f). When the control element 16f is in a mounted state, the guide elements 28f are arranged at an end 34f of the control element 16f that faces away from a transmission housing (not represented in greater detail here) of a power tool housing 40f of the angle grinder 38f. In addition, the guide unit 20f comprises two further guide elements 30f that, when the control element 16f is in a mounted state, are arranged at an end 36f of the control element 16f that faces toward the transmission housing (FIG. 11 shows only one of the two further guide elements 300. The further guide elements 30f are likewise realized as pendulum rods. The guide elements 28f, realized as pendulum rods, and the further guide elements 30f, realized a pendulum rods, are movably mounted on the control element 16f. The control element 16f in this case comprises trunnions 92f, on each of which one of the guide elements 28f or the further guide elements 30f is movably mounted. In addition, the guide elements 28f, realized as pendulum rods, and the further guide elements 30f, realized as pendulum rods, are arranged in a movable manner on an inside of a motor housing 44f, or of a main handle 46f of the power tool housing 40f, that faces toward the control element 16f. The motor housing 44f, or the main handle 46f, in this case comprises trunnions 94f, on each of which one of the guide elements 28f or the further guide elements 30f is movably mounted. The guide unit 20f is thus realized as a pendulum rod guide unit. The guide elements 28f and the further guide elements 30f are arranged relative to each other in a manner at least substantially similar to that of the guide elements 28a and the further guide elements 30a described in the description of FIGS. 1 to 3.

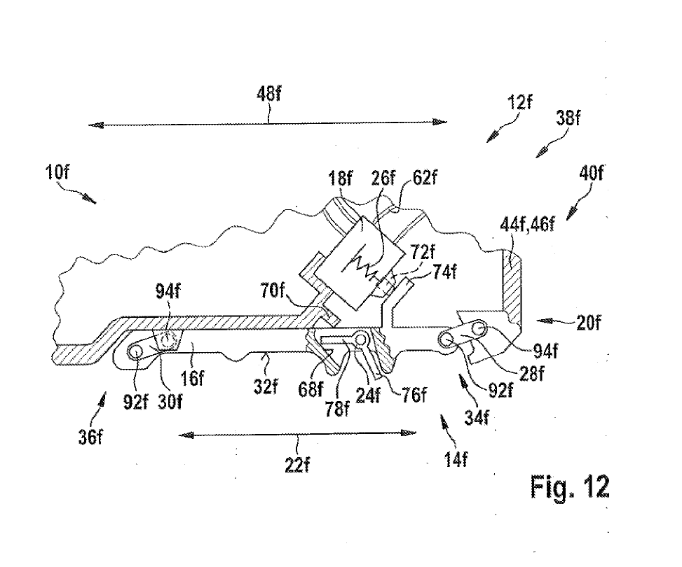

In addition, for the purpose of actuating an actuating striker 72f of the switching element 18f, the control element 16f comprises an actuating extension 74f, which is arranged relatively obliquely in relation to the direction of main extent 22f of the control element 16f, on a side of the control element 16f that faces away from a control surface 32f of the control element 16f. The actuating extension 74f is provided to exert an actuating force upon the actuating striker 72f when the control element 16f is in a switch-on position (FIG. 12). In addition, the switching unit 14f comprises a blocking element 24f, which is movably arranged on the control element 16f. The blocking element 24f in this case is of a design similar to the design of the blocking element 24a described in the description of FIGS. 1 to 3.

What is claimed is:

1. A power tool switching device, comprising:
at least one switching unit having at least one movably mounted control element configured to actuate a mechanical, electrical and/or electronic switching element; and
at least one guide unit, which, upon an actuation of the control element along a direction of main extent of the control element, is configured to convert a movement of the control element along the direction of main extent at least into a movement of the control element running transversely in relation to the direction of main extent.

2. The power tool switching device according to claim 1, wherein the switching unit has at least one blocking element configured to block a movement of the control element in at least one direction in at least one operating state.

3. The power tool switching device according to claim 1, wherein the switching unit has at least one spring element configured to apply a spring force to the control element in at least one operating position.

4. The power tool switching device according to claim 1, wherein the guide unit is embodied as one or more of a slideway guide unit and a pendulum rod guide unit.

5. The power tool switching device according to claim 1, wherein the guide unit has at least one guide element configured to mount the control element in a swiveling manner.

6. The power tool switching device according to claim 5, wherein the guide unit has at least one further guide element embodied as a groove, which has a guide track course that is at least partially angled relative to the direction of main extent of the control element at least when the control element is in an initial position.

7. The power tool switching device according to claim 4, wherein the guide unit has at least one guide element embodied as a pendulum rod.

8. The power tool switching device according to claim 7, wherein the guide element embodied as a pendulum rod is movably mounted on the control element.

9. The power tool switching device according claim 1, wherein the control element has at least two ends that face away from each other as viewed along the direction of main extent, wherein at least one guide element of the guide unit is arranged at one end, and wherein at least one further guide element of the guide unit is arranged at a further end that faces away from the end when the control element is in the mounted state.

10. A portable power tool, comprising:
a power tool switching device including:
at least one switching unit having at least one movably mounted control element configured to actuate a mechanical, electrical and/or electronic switching element; and
at least one guide unit, which, upon an actuation of the control element along a direction of main extent of the control element, is configured to convert a movement of the control element along the direction of main extent at least into a movement of the control element running transversely in relation to the direction of main extent.

11. The power tool switching device according to claim 1, wherein the power tool switching device is configured for portable power tools.
